(19) United States
(12) Patent Application Publication
(10) Pub. No.: US 2016/0169173 A1
(43) Pub. Date: Jun. 16, 2016

(54) PULSATION DAMPER AND HIGH-PRESSURE FUEL PUMP

(71) Applicant: TOYOTA JIDOSHA KABUSHIKI KAISHA, Toyota-shi, Aichi-ken (JP)

(72) Inventor: Takeyuki YABUUCHI, Toyota-shi (JP)

(73) Assignee: TOYOTA JIDOSHA KABUSHIKI KAISHA, Toyota-shi, Aichi-ken (JP)

(21) Appl. No.: 14/906,785

(22) PCT Filed: Jul. 21, 2014
(86) PCT No.: PCT/IB2014/001360

§ 371 Date: Jan. 21, 2016

(30) Foreign Application Priority Data
Jul. 23, 2013 (JP) 2013-152224

(51) Int. Cl. F02M 55/04; F02M 59/44; F04B 53/00; F02M 59/10

(52) U.S. Cl. CPC F02M 55/04; F02M 59/102; F02M 59/44; F04B 53/001

(57) ABSTRACT

A pulsation damper (20) includes a first diaphragm (21) and a second diaphragm (22) having a first pressure-receiving film portion (21a) and a second pressure-receiving film portion (22a) and defining a gas chamber (23) between the first pressure-receiving film portion (21a) and the second pressure-receiving film portion (22a) and an annular attachment member (24) configured to support the first diaphragm (21) and the second diaphragm (22). Pressure receiving areas (A1, A2) of the first pressure-receiving film portion (21a) and the second pressure-receiving film portion (22a) are different from each other. The annular attachment member (24) includes a large-diameter annular support portion (24a) formed so as to surround the first pressure-receiving film portion (21a) and to support the first diaphragm (21); a small-diameter annular support portion (24b) formed so as to surround the second pressure-receiving film portion (22a) and to support the second diaphragm (22); and an annular coupling portion (24c) configured to couple the large-diameter annular support portion (24a) with the small-diameter annular support portion (24b) so as to close the gas chamber (23).

### BACKGROUND OF THE INVENTION

1. Field of the Invention

The present invention relates to a pulsation damper and a high-pressure fuel pump, and particularly to a pulsation damper including a gas chamber formed by a diaphragm, and a high-pressure fuel pump including the pulsation damper.

2. Description of Related Art

As a pulsation damper for restraining fluid pressure pulsation, a pulsation damper including a diaphragm configured to receive a fuel pressure on one side and a gas chamber formed on the other side of the diaphragm is often used. This type of pulsation damper is attached to a plunger-type high-pressure fuel pump configured to pressure-feed a high-pressure fuel to an internal combustion engine that is able to perform cylinder injection (cylinder direct fuel injection), for example. The pulsation damper is configured to absorb that relatively high-frequency pulsation of an intake-side fuel pressure which is caused along with a pump operation, so as to reduce the pulsation.

As a conventional pulsation damper and a conventional high-pressure fuel pump, there has been known such a technique that, in order to prevent so-called opening in which a joint surface of a diaphragm is gradually peeled off from an inner side of a gas chamber, for example, a filmy displacement portion opposed to a support member, and a tubular member extending perpendicularly from the displacement portion are provided, and the tubular member is joined to an annular joint surface of the support member in a state where the tubular member is fitted to the annular joint surface (for example, see International Publication No. 2010/106645).

Further, there has been proposed such a technique that outer peripheral portions of diaphragms having different sizes are attached to both sides of a support plate having a communication path, so as to form two large and small gas chambers (for example, see Japanese Patent Application Publication No. 2007-309118 (JP 2007-309118 A)). Also, there has been proposed such a technique that a gas chamber is constituted by a cover attached to a pump body of a high-pressure fuel pump so as to form an intake fuel accumulation chamber thereof, and a diaphragm opposed to an inner wall surface of the cover (for example, see Japanese Patent Application Publication No. 2010-270727 (JP 2010-270727 A)).

### SUMMARY OF THE INVENTION

In a conventional pulsation damper and a conventional high-pressure fuel pump in each of which a gas chamber is formed between a single diaphragm and a cover member or the like of a pump housing, flexure in a direction perpendicular to a pressure receiving surface of the diaphragm is large. This causes the diaphragm to vibrate at a large amplitude, thereby inducing vibration of a fuel pipe, its support member, and so on, which might decrease a pulsation reduction performance. Further, when a large vibration occurring in the diaphragm is transmitted from the high-pressure fuel pump to a vehicle-body side via the fuel pipe or transmitted to an engine or the like that supports the high-pressure fuel pump, interior car noise and the like might be caused.

Further, in a conventional pulsation damper and a conventional high-pressure fuel pump each of which uses two diaphragms, outer peripheral portions of the two diaphragms are supported by face-joining to a plate-shaped attachment member. On that account, the plate-shaped attachment member receives a force in a plate-thickness direction from a diaphragm side. Accordingly, when diaphragms having different sizes are used together, vibration (e.g., circular film vibration) in a flexure direction is easily induced by the plate-shaped attachment member, thereby resulting in that the vibration is easily transmitted from the attachment member to a support-side member such as' a cover of a pump housing. Further, when diaphragms having the same size are used together, two diaphragms may cause resonance frequencies at the same time, so that the resonance frequencies are combined, thereby causing a large amplitude. This induces vibration of a fuel pipe, its support member, and so on, which might decrease a pulsation reduction performance or increase the vibration.

The present invention provides a pulsation damper and a high-pressure fuel pump each of which is able to secure a sufficient pulsation damping performance by use of a plurality of diaphragms, and to restrain vibration transmission to a support side even if diaphragms having different sizes are used together.

A pulsation damper according to an aspect of the present invention includes a first diaphragm including a first pressure-receiving film portion displaced upon receipt of a pressure, a second diaphragm including a second pressure-receiving film portion displaced upon receipt of a pressure, the second pressure-receiving film portion having a pressure receiving area different from a pressure receiving area of the first pressure-receiving film portion, and an annular attachment member configured to support the first diaphragm and the second diaphragm from outer peripheral sides of the first and the second pressure-receiving film portions, the annular attachment member including a large-diameter annular support portion surrounding the first pressure-receiving film portion and supporting the first diaphragm, a small-diameter annular support portion surrounding the second pressure-receiving film portion and supporting the second diaphragm, and an annular coupling portion coupling the large-diameter annular support portion with the small-diameter annular support portion so as to close a gas chamber between the first pressure-receiving film portion and the second pressure-receiving film portion.

According to the above aspect, a gas chamber is formed between the first pressure-receiving film portion having a large pressure receiving area and the second pressure-receiving film portion having a small pressure receiving area, and the annular attachment member surrounding the gas chamber is configured such that relatively large forces from the first diaphragm and the second diaphragm axially reversely act on the large-diameter annular support portion and the small-diameter annular support portion that are relatively close to each other in a radial direction. Accordingly, the annular attachment member is hard to bend and hard to vibrate. Resonance frequencies of the first diaphragm and the second diaphragm are different from each other. This makes it possible to prevent a decrease in a pulsation reduction performance and an increase of vibration, which are caused when the resonances of the diaphragms are overlapped with each other to be combined and to cause a large amplitude. Accordingly, it is possible to provide a pulsation damper that is able to secure a sufficient pulsation damping performance by use of a plurality of diaphragms, and to restrain vibration transmission to a support side even if diaphragms having different sizes are used together.

The pulsation damper of the present invention may be configured such that the large-diameter annular support portion and the small-diameter annular support portion have tubular support wall surfaces and the large-diameter annular support portion and the small-diameter annular support portion have different diameters.

According to the above aspect, the annular attachment member receives axially reverse forces from the first diaphragm and the second diaphragm along the large and small tubular support wall surfaces. Accordingly, the annular attachment member is hard to bend, and in addition to that, it is possible to easily and sufficiently secure a joining strength of the annular attachment member with respect to the first diaphragm and the second diaphragm, and seal characteristics therebetween.

In the above aspect, the large-diameter annular support portion and the small-diameter annular support portion may have the tubular support wall surfaces on respective outer peripheral sides of the large-diameter annular support portion and the small-diameter annular support portion; and the annular coupling portion may be placed between the large-diameter annular support portion and the small-diameter annular support portion and has an annular plate shape.

According to the above aspect, it is possible to reduce a weight of the annular attachment member and to form the annular attachment member from sheet metal or the like, for example, thereby making it possible to reduce a manufacturing cost of the pulsation damper.

In the above aspect, respective one sides of the first pressure-receiving film portion and the second pressure-receiving film portion may be opposed to each other, the respective one sides defining the gas chamber; and at least the second diaphragm out of the first diaphragm and the second diaphragm may have a tubular circumferential portion surrounding the second pressure-receiving film portion from the outer peripheral side of the second pressure-receiving film portion.

According to the above aspect, it is possible to place the first and second pressure-receiving film portions generally in parallel to each other, thereby making it possible to form a compact pulsation damper. Further, this achieves easy attachment of at least the second diaphragm and an increase of its seal characteristic.

In the above aspect, the annular attachment member may include protruding portions projecting radially outwardly.

According to the above aspect, it is possible to effectively restrain vibration transmission from the annular attachment member to the support side or vibration transmission in its reverse direction.

In the above aspect, the protruding portions may be configured to be elastically deformed in a direction perpendicular to the first pressure-receiving film portion and the second pressure-receiving film portion.

According to the above aspect, it is possible to elastically support the annular attachment member and to more effectively restrain the vibration transmission to the support side.

In the above aspect, the protruding portions may be constituted by three or more elastic plate portions projecting radially outwardly from the annular attachment member.

According to the above aspect, it is possible to elastically support the annular attachment member and stabilize its support posture, thereby making it possible to more effectively restrain vibration transmission to the support side.

In the above aspect, the pulsation damper may further include a support-side member, and the support-side member may include: an inner peripheral wall portion surrounding the annular attachment member from an outer peripheral side of the annular attachment member; and a latching portion provided along the inner peripheral wall portion so as to latch the protruding portions of the annular attachment member to the inner peripheral wall portion.

According to the above aspect, it is possible to elastically support the annular attachment member just by latching the protruding portions of the annular attachment member to the latching portion of the support-side member, and its assembling operation becomes easy.

In the above aspect, a plurality of annular attachment members may be provided inside the inner peripheral wall portion of the support-side member; and the plurality of annular attachment members may be supported so as to be axially separated from each other.

According to the above aspect, it is possible to easily mount a necessary number of pulsation dampers on the inner peripheral wall portion of the support side member without separately providing other attachment members, and to obtain a sufficient pulsation reduction effect.

In the above aspect, the protruding portions projecting radially outwardly from the annular attachment member may be engaged with the inner peripheral wall portion by the latching portion in a radial direction in a recess-projection manner.

According to the above aspect, it is possible to easily mount a necessary number of pulsation dampers on the inner peripheral wall portion of the support side member with a single touch.

A high-pressure fuel pump according to the present invention includes: the pulsation damper according to any one of claims 1 to 10; an intake-side fuel accumulation chamber housing therein the pulsation damper; an intake passage communicating with the intake-side fuel accumulation chamber; and a fuel pressurization mechanism configured to pressurize a fuel introduced via the intake passage so as to discharge the fuel.

According to the above aspect, it is possible to sufficiently damp a fuel pressure pulsation on an intake side. Further, it is possible to provide a high-pressure fuel pump that is able to restrain vibration transmission to the support side while using diaphragms having different sizes together

According to the above aspect, it is possible to provide a pulsation damper and a high-pressure fuel pump each of which is able to secure a sufficient pulsation damping performance by use of a plurality of diaphragms, and to restrain vibration transmission to a support side even if diaphragms having different sizes are used together.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic configuration diagram of a fuel supply system including a high-pressure fuel pump including a pulsation damper according to one embodiment of the present invention;

FIG. 2 is a sectional view of an essential part of the pulsation damper according to the one embodiment of the present invention;

FIG. 3A is a top view of the essential part of the pulsation damper according to the one embodiment of the present invention;

FIG. 3B is a bottom view of the essential part of the pulsation damper according to the one embodiment of the present invention;

FIG. 4 is a sectional view including a support-side member of the pulsation damper according to the one embodiment of the present invention;

FIG. 5A is an explanatory view of an interaction of the pulsation damper according to the one embodiment of the present invention;

FIG. 5B is an explanatory view of an interaction of a pulsation damper according to a comparative example of the present invention; and

FIG. 6 is a sectional view illustrating a modified embodiment of a first diaphragm of the pulsation damper according to the one embodiment of the present invention.

### DETAILED DESCRIPTION OF EMBODIMENTS

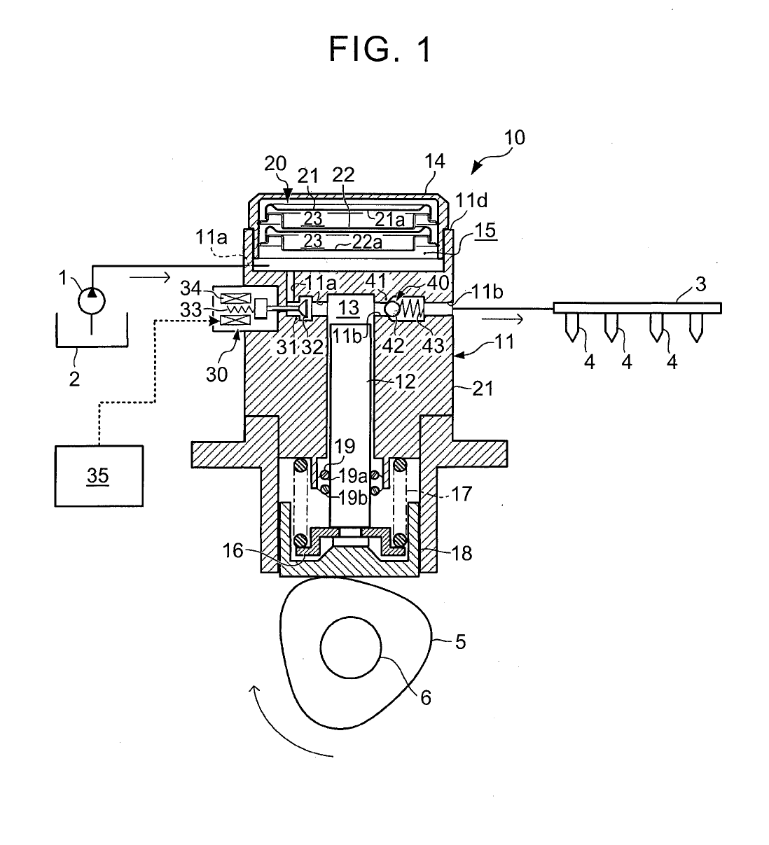

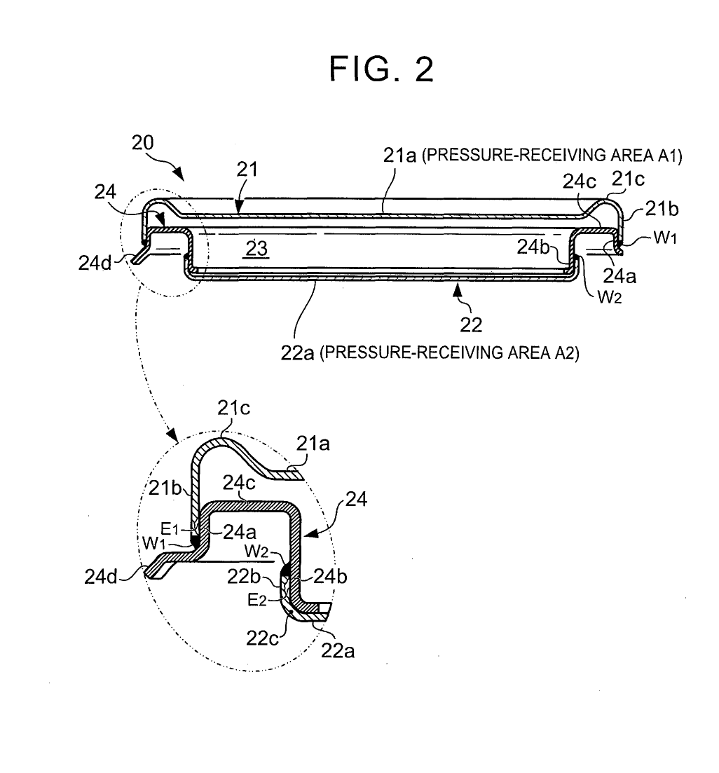

FIG. 1 illustrates a schematic configuration of a fuel supply system including a high-pressure fuel pump including a pulsation damper according to one embodiment of the present invention. FIGS. 2 to 4 illustrate the pulsation damper according to the one embodiment.

First described is a schematic configuration of the high-pressure fuel pump according to the present embodiment. A high-pressure fuel pump 10 of the present embodiment as illustrated in FIG. 1 is provided in an internal combustion engine mounted in a vehicle, and discharges a fuel for the engine by pressurizing the fuel to a high pressure that enables cylinder injection. The internal combustion engine is, for example, a multi-cylinder gasoline engine (hereinafter, just referred to as “engine”) of a so-called cylinder injection type or dual injection type that is able to perform cylinder direct fuel injection.

As illustrated in FIG. 1, the high-pressure fuel pump 10 of the present embodiment includes: a housing 11 including an intake-side fuel passage 11a and a discharge-side fuel passage 11b; and a generally columnar plunger 12 disposed in the housing 11 axially slidably in a reciprocating manner.

A fuel pressurization chamber 13 connecting the intake-side fuel passage 11a to the discharge-side fuel passage 11b is defined between the housing 11 and the plunger 12. The fuel pressurization chamber 13 is configured such that, when the plunger 12 is displaced axially, a volume of the fuel pressurization chamber 13 changes.

Further, a cover 14 having a bottomed cylindrical shape is attached to an upper portion 11d of the housing 11 in FIG. 1. A fuel accumulation chamber 15 communicating with the intake-side fuel passage 11a is defined by the housing 11 and the cover 14. A pulsation damper 20 of the present embodiment is provided inside the fuel accumulation chamber 15.

A low-pressure fuel pump 1 is connected via a pipe to the intake-side fuel passage 11a of the housing 11. A plurality of injectors 4 (fuel injection valves) for cylinder injection is connected to the discharge-side fuel passage 11b of the housing 11 via a delivery pipe 3, which is a high-pressure fuel pipe.

The low-pressure fuel pump 1 is configured to pump up a fuel, e.g., gasoline, in a fuel tank 2 and to discharge the fuel while pressurizing the fuel to a predetermined feed pressure (e.g., 250 to 400 KPa). Note that the low-pressure fuel pump 1 is constituted by, for example, a motorized circumferential flow pump or the like configured to rotationally drive a pump impeller by a drive motor.

The delivery pipe 3 accumulates therein the fuel at a high pressure (e.g., 4 to 13 MPa) which is discharged from the high-pressure fuel pump 10, and accumulates its pressure. The plurality of injectors 4 for cylinder injection respectively corresponding to a plurality of cylinders of the engine is directly connected to the delivery pipe 3 so that the plurality of injectors 4 is separated from each other at predetermined intervals. At the time when each of the injectors 4 is opened, the high-pressure fuel in the delivery pipe 3 is supplied to the each of the injectors 4.

Further, the plunger 12 is always biased downward in FIG. 1 relative to the housing 11 via a spring support plate 16 and a return spring 17. The plunger 12 abuts with a driving cam 5 via a follower lifter 18 slidable in an up-down direction in the figure relative to the housing 11. Further, a seal unit 19 including a fuel seal 19a on a fuel-pressurization-chamber side and an oil seal 19b on a driving-cam-5 side is provided between the plunger 12 and the housing 11.

A driving cam 5 has a cam profile configured such that a lift amount is increased in at least one part thereof in a circumferential direction. The cam profile is a cam profile having a generally polygonal shape in which corners are rounded, for example. The driving cam 5 is integrally attached to an exhaust-side or an intake-side camshaft 6 of the engine, for example, and is rotationally driven by power of the engine. When the driving cam 5 is rotationally driven, the plunger 12 reciprocates in the up-down direction in FIG. 1 according to a rotation thereof, so that the volume of the fuel pressurization chamber 13 is changed.

The high-pressure fuel pump 10 further includes an intake valve unit 30 and a discharge valve unit 40. The intake valve unit 30 includes a valve seat 31 forming part of the intake-side fuel passage 11 a and having an annular stepped shape of which a downstream-side diameter is large. The intake valve unit 30 includes an intake valve body 32 that is displaceable in a central-axis direction of the valve seat 31 so that the intake valve body 32 is engaged with and disengaged from the valve seat 31. The intake valve unit 30 includes a valve spring 33 configured to bias the intake valve body 32 in a valve-opening direction so as to be separated from the valve seat 31. The intake valve unit 30 includes a solenoid coil 34 configured to bias the intake valve body 32 in a valve-closing direction so as to be engaged with the valve seat 31.

In response to a control signal from an electronic control unit (ECU) 35, the solenoid coil 34 is excited by current application for a pressurization period and a discharge period according to a requested discharge amount. Then, the intake valve body 32 is biased by the solenoid coil 34 in the valve-closing direction against a biasing force of the valve spring 33, thereby enabling pressurization and discharge of the fuel in the fuel pressurization chamber 13 according to reciprocation displacement of the plunger 12. Note that the intake valve unit 30 used herein is a normally-open type. The intake valve unit 30 may be a normally-closed type.

The discharge valve unit 40 includes a valve seat 41 forming part of the discharge-side fuel passage 11b and having a tapered wall surface shape of which a downstream-side diameter is large. The discharge valve unit 40 includes a spherical discharge valve body 42 that is displaceable in a central-axis direction of the valve seat 41 so that the discharge valve body 42 is engaged with and disengaged from the valve seat 41. The discharge valve unit 40 includes a valve spring 43 biasing the discharge valve body 42 in a valve-closing direction where the discharge valve body 42 comes close to the valve seat 41. The discharge valve unit 40 is a check valve type including the valve seat 41, the discharge valve body 42, and the valve spring 43.

Next will be described a pulsation damper 20 of the present embodiment attached to the high-pressure fuel pump 10. As illustrated in FIG. 2, the pulsation damper 20 includes a first diaphragm 21 and a second diaphragm 22, and an annular attachment member 24 configured to support the first diaphragm 21 and the second diaphragm 22 and to be attachable inside a cap-shaped cover 14 (a support-side member).

The first diaphragm 21 includes: a first pressure-receiving film portion 21a, which is a generally disciform elastic film to be displaced upon receipt of a pressure; a first tubular member 21b surrounding the first pressure-receiving film portion 21a from its outer peripheral side; and an annular curved coupling portion 21c coupled the first pressure-receiving film portion 21a with the first tubular member 21b.

The second diaphragm 22 includes: a second pressure-receiving film portion 22a, which is a generally disciform elastic film to be displaced upon receipt of a pressure; a second tubular member 22b surrounding the second pressure-receiving film portion 22a from its outer peripheral side; and an annular curved coupling portion 22c coupled the second pressure-receiving film portion 22a with the second tubular member 22b.

A gas chamber 23 surrounded by the annular attachment member 24 is formed between the first pressure-receiving film portion 21a of the first diaphragm 21 and the second pressure-receiving film portion 22a of the second diaphragm 22.

Here, while a gas pressure in the gas chamber 23 is received by one sides of the first pressure-receiving film portion 21a and the second pressure-receiving film portion 22a, a fuel pressure in the fuel accumulation chamber 15 is received by the other sides of the first pressure-receiving film portion 21a and the second pressure-receiving film portion 22a. Hereby, the first pressure-receiving film portion 21a and the second pressure-receiving film portion 22a are deformed and displaced in an inward or outward direction of the gas chamber 23 according to a pressure difference between the gas pressure and the fuel pressure with respect to the first pressure-receiving film portion 21a and the second pressure-receiving film portion 22a.

In the gas chamber 23, inert gas, e.g., argon gas or nitrogen gas is enclosed at a predetermined pressure of about a feed pressure, which is a fuel supply pressure from the low-pressure fuel pump 1.

The annular attachment member 24 supports the first diaphragm 21 and the second diaphragm 22 from outer peripheral sides of the first pressure-receiving film portion 21a and the second pressure-receiving film portion 22a, so as to integrally couple the first diaphragm 21 with the second diaphragm 22 via annular welded portions indicated by W1, W2 in FIG. 2 by laser beam welding, for example, thereby airtightly sealing the gas chamber 23.

Further, a pressure receiving area A1 of the first pressure-receiving film portion 21a of the first diaphragm 21 is different from a pressure receiving area A2 of the second pressure-receiving film portion 22a of the second diaphragm 22. The pressure receiving area A1 of the first pressure-receiving film portion 21a of the first diaphragm 21 is larger than the pressure receiving area A2 of the second pressure-receiving film portion 22a of the second diaphragm 22 (A1>A2).

Further, the annular attachment member 24 includes a large-diameter annular support portion 24a surrounding the first pressure-receiving film portion 21a from its outer peripheral side and supporting the first diaphragm 21. The annular attachment member 24 includes a small-diameter annular support portion 24b surrounding the second pressure-receiving film portion 22a from its outer peripheral side and supporting the second diaphragm 22. The annular attachment member 24 includes an annular coupling portion 24c integrally and airtightly coupling the large-diameter annular support portion 24a with the small-diameter annular support portion 24b so as to close the gas chamber 23.

The annular attachment member 24 is formed by bending sheet metal so that the annular coupling portion 24c is positioned on axial one end sides of the cylindrical large-diameter annular support portion 24a and the cylindrical small-diameter annular support portion 24b, for example.

Further, the annular attachment member 24 may be made from a sheet metal material having a large plate thickness so that its rigidity is larger than those of sheet metal materials of the first diaphragm 21 and the second diaphragm 22. Further, the material of the annular attachment member 24 may be more rigid than the materials of the first diaphragm 21 and the second diaphragm 22. The annular attachment member 24 may be made from a sheet metal material having a large plate thickness so that its rigidity is larger than those of sheet metal materials for the first diaphragm 21 and the second diaphragm 22, and further, the material of the annular attachment member 24 may be more rigid than the materials of the first diaphragm 21 and the second diaphragm 22.

When the first pressure-receiving film portion 21a of the first diaphragm 21 and the second pressure-receiving film portion 22a of the second diaphragm 22 are deformed and displaced according to the pressure difference between the gas pressure in the gas chamber 23 and the fuel pressure in the fuel accumulation chamber 15, the annular attachment member 24 is able to support tip sides of the tubular members 21b, 22b of the first diaphragm 21 and the second diaphragm 22, as generally fixed ends.

The large-diameter annular support portion 24a and the small-diameter annular support portion 24b of the annular attachment member 24 respectively have large-diameter and small-diameter tubular support wall surfaces E1, E2 having different diameters (see a partial enlarged view in FIG. 2) on their outer peripheral sides.

That is, the large-diameter tubular support wall surface E1 is part of an outer peripheral surface of the large-diameter annular support portion 24a, and a predetermined fitting margin is set with respect to an inner peripheral surface (without any reference sign) of the first tubular member 21b of the first diaphragm 21. Further, the small-diameter tubular support wall surface E2 is part of an outer peripheral surface of the small-diameter annular support portion 24b, and a predetermined fitting margin is set with respect to an inner peripheral surface (without any reference sign) of the second tubular member 22b of the second diaphragm 22.

In a state where the inner peripheral surface of the first tubular member 21b of the first diaphragm 21 is fitted to the large-diameter tubular support wall surface E1 of the large-diameter annular support portion 24a of the annular attachment member 24, a tip annular portion (a lower end portion in FIG. 2) of the first tubular member 21b of the first diaphragm 21 is airtightly coupled with the large-diameter annular support portion 24a of the annular attachment member 24 by laser beam welding.

Further, in a state where the inner peripheral surface of the second tubular member 22b of the second diaphragm 22 is fitted to the small-diameter tubular support wall surface E2 of the small-diameter annular support portion 24b of the annular attachment member 24, a tip annular portion (an upper end portion in FIG. 2) of the second tubular member 22b of the second diaphragm 22 is airtightly coupled with the small-diameter annular support portion 24b of the annular attachment member 24 by laser beam welding.

The large-diameter annular support portion 24a and the small-diameter annular support portion 24b of the annular attachment member 24 are formed in double cylindrical shapes having the same central axis. The annular coupling portion 24c is placed between the large-diameter annular support portion 24a and the small-diameter annular support portion 24b, and has an annular plate shape. Further, respective one sides of the first pressure-receiving film portion 21a of the first diaphragm 21 and the second pressure-receiving film portion 22a of the second diaphragm 22, which respective form the gas chamber 23, are opposed to each other generally in parallel to each other.

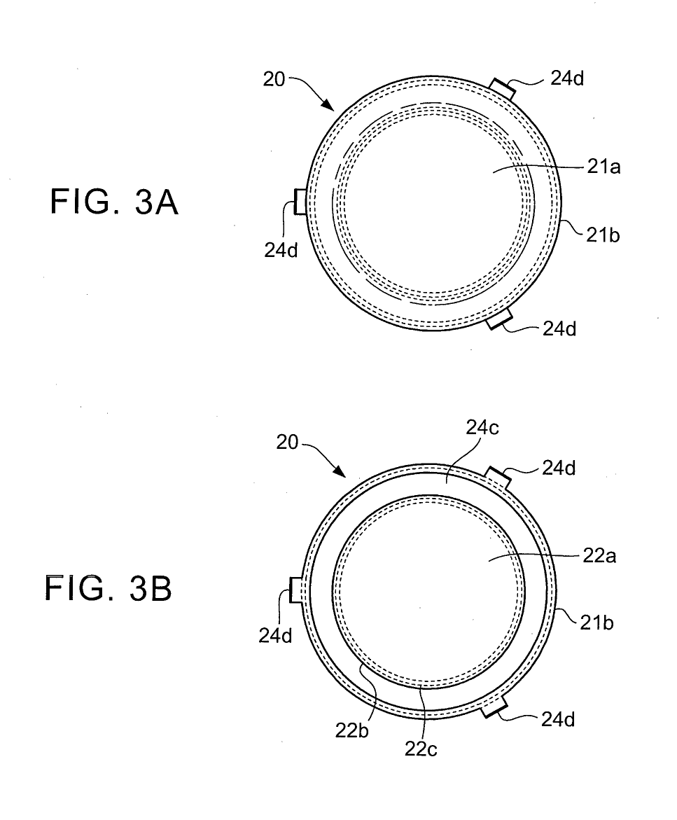

As illustrated in FIGS. 3A, 3B, the annular attachment member 24 includes a plurality of (e.g., three or more) elastic plate-shaped protruding portions 24d (elastic plate portions; in FIG. 3, three elastic plate portions) projecting radially outwardly and elastically deformable in a direction perpendicular to the first and second pressure-receiving film portions 21a, 22a. The protruding portions 24d are used as attachment protruding portions 24d via which the annular attachment member 24 is attached to the cover.

The plurality of protruding portions 24d is inclined obliquely and downward as illustrated in FIG. 2 so that tip positions of the plurality of protruding portions 24d are placed on a circumference having a diameter larger than an inside diameter of the cover 14 and the tip positions are placed on larger radius positions as they come closer to a bottom end of the cover 14 in FIG. 1. Hereby, the plurality of protruding portions 24d has an elastic claw shape fittable into the cover 14. Note that, as illustrated in the partial enlarge view in FIG. 2, the plurality of protruding portions 24d may have such a flange shape that only tip side parts of the plurality of protruding portions 24d are inclined diagonally and downward, and base side parts thereof are generally perpendicular to the large-diameter annular support portion 24a of the annular attachment member 24.

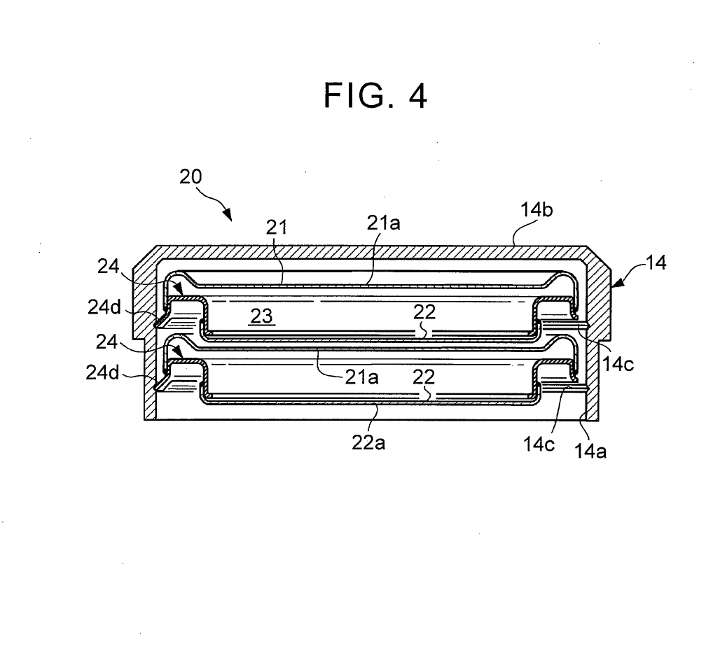

More specifically, as illustrated in FIG. 4, the cover 14 is a support-side member including: an inner peripheral wall portion 14a surrounding the annular attachment member 24 from its outer peripheral side; a top wall portion 14b closing an upper end side of the inner peripheral wall portion 14a (see FIG. 1); and a latching groove portion 14c (a latching portion) configured to latch (lock) the protruding portions 24d of the annular attachment member 24 to the inner peripheral wall portion 14a. The latching groove portion 14c is formed to have a generally V-shaped section. By means of the latching groove portion 14c of the cover 14, the protruding portions 24d projecting radially outwardly from the annular attachment member 24 are engaged with the inner peripheral wall portion 14a in a radial direction in a recess-projection manner.

The cover 14 has a bottomed cylindrical shape formed in a downward recessed shape in FIG. 1 so as to define the fuel accumulation chamber 15 between the cover 14 and the housing 11. The cover 14 is airtightly coupled with a cylindrical upper portion 11d of the housing 11 by screw-thread fastening, brazing, or the like.

As illustrated in FIG. 4, in the present embodiment, a plurality of annular attachment members 24 are provided inside the inner peripheral wall portion 14a of the bottomed cylindrical cover 14. The plurality of annular attachment members 24, for example, a pair of annular attachment members 24, is supported so as to be axially separated from each other.

The high-pressure fuel pump 10 according to the present embodiment includes a pair of pulsation damper 20. The high-pressure fuel pump 10 of the present embodiment includes the fuel accumulation chamber 15 (an intake-side fuel accumulation chamber) accommodating therein the pulsation dampers 20, and the intake-side fuel passage 11a (an intake passage) communicating with the fuel accumulation chamber 15.

The high-pressure fuel pump 10 of the present embodiment includes a fuel pressurization mechanism 50 configured to pressurize, by the plunger 12, a fuel introduced into the fuel pressurization chamber 13 via the intake-side fuel passage 11a and to discharge the fuel from the fuel pressurization chamber 13.

Here, the fuel pressurization mechanism 50 includes: the housing 11; the plunger 12 defining the fuel pressurization chamber 13 in the housing 11; the intake valve unit 30 controlled to be opened or closed appropriately according to a requested discharge amount during a reciprocating movement of the plunger 12; and a discharge valve unit 40 configured to be opened when a fuel pressure on a fuel-pressurization-chamber-13 side becomes larger than a fuel pressure on a delivery-pipe-3 side by a predetermined valve opening pressure or more.

Next will be described an interaction. In the high-pressure fuel pump 10 and the pulsation damper 20 of the present embodiment configured as described above, the gas chamber 23 is formed between the first pressure-receiving film portion 21a and the second pressure-receiving film portion 22a respectively having the pressure receiving area A1 and the pressure receiving area A2 different from each other. The annular attachment member 24 includes the large-diameter annular support portion 24a, the small-diameter annular support portion 24b, and the annular coupling portion 24c configured to couple the large-diameter annular support portion 24a with the small-diameter annular support portion 24b so as to close the gas chamber 23.

Accordingly, in the annular attachment member 24 surrounding the gas chamber 23 between the first pressure-receiving film portion 21a and the second pressure-receiving film portion 22a, relatively large forces from the first diaphragm 21 and from the second diaphragm 22 axially reversely act on the large-diameter annular support portion 24a and on the small-diameter annular support portion 24b that are relatively close to each other in the radial direction. Accordingly, the annular attachment member 24 is hard to bend and hard to vibrate. Besides, at least one of the first diaphragm 21 and the second diaphragm 22 is separated from a support point (a radius position of the inner peripheral wall portion 14a) of the annular attachment member 24 with respect to a cover-14 side. Accordingly, vibrations of the first diaphragm 21 and the second diaphragm 22 are hard to be transmitted to the cover-14 side.

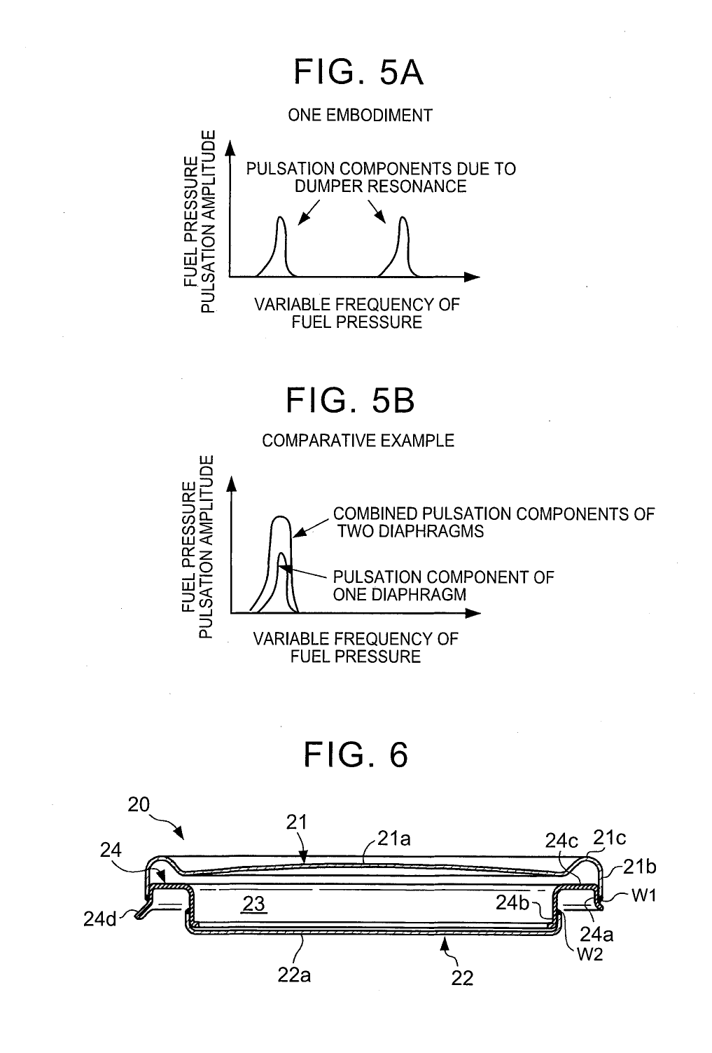

Further, in the present embodiment, as illustrated in FIG. 5A, resonance frequencies of the first diaphragm 21 and the second diaphragm 22 having different pressure receiving areas are different from each other. In view of this, differently from a comparative example illustrated in FIG. 5B, resonances of two diaphragms are not overlapped with each other to be combined, thereby resulting in that an amplitude is not increased. Accordingly, in the present embodiment, it is possible to restrain vibration of the fuel pipe and the like.

Accordingly, with the use of the plurality of different diaphragms 21, 22, it is possible to secure a sufficient pulsation damping performance, to restrain vibration transmission to a support side such as the engine and a head cover, and to prevent a decrease in the pulsation damping performance and an increase of vibration. As the plurality of different diaphragms 21, 22, diaphragms 21, 22 having different sizes may be used together, for example.

Further, in the present embodiment, the large-diameter annular support portion 24a and the small-diameter annular support portion 24b of the annular attachment member 24 have the large-diameter tubular support wall surface E1 and the small-diameter tubular support wall surface E2 having different diameters. Accordingly, the annular attachment member 24 is hard to bend, and in addition to that, it is possible to easily and sufficiently secure a strength of joining of the annular attachment member 24 with respect to the first diaphragm 21 and the second diaphragm 22 by use of fitting and fixation by laser beam welding, and seal characteristics of joining parts therebetween.

Further, in the present embodiment, the large-diameter annular support portion 24a and the small-diameter annular support portion 24b of the annular attachment member 24 are formed in double cylindrical shapes. The annular coupling portion 24c is placed between the large-diameter annular support portion 24a and the small-diameter annular support portion 24b, and has an annular plate shape. Accordingly, it is possible to reduce a weight of the annular attachment member 24 by forming the annular attachment member 24 from sheet metal or the like. This makes it possible to reduce a manufacturing cost of the pulsation damper 20.

In addition, in the present embodiment, respective one sides of the first pressure-receiving film portion 21a and the second pressure-receiving film portion 22a, the respective one sides defining the gas chamber 23, are opposed to each other. Accordingly, it is possible to place the first pressure-receiving film portion 21a and the second pressure-receiving film portion 22a generally in parallel to each other. This makes it possible to form the pulsation damper 20 compactly.

Besides, at least the small-diameter second diaphragm 22 includes the tubular member 22b fitted to the outer peripheral side of the annular attachment member 24. This achieves easy attachment of the diaphragm 22 and also increases its seal characteristic. In the present embodiment, both of the first diaphragm 21 and the second diaphragm 22 include the tubular members 21b, 22b fitted to the outer peripheral sides of the annular attachment member 24. This accordingly achieves easy attachment of both of the diaphragms 21, 22 and also increases their seal characteristics.

Further, the annular attachment member 24 includes the protruding portions 24d projecting radially outwardly and provided between the annular attachment member 24 and an engine side. This makes it possible to effectively restrain vibration transmission from the annular attachment member 24 to the engine side or vibration transmission in a reverse direction to the above, by means of the protruding portions 24d.

Further, the annular attachment member 24 is configured to be elastically deformed in a direction perpendicular to the first pressure-receiving film portion 21a and the second pressure-receiving film portion 22a. Accordingly, it is possible to elastically support the annular attachment member 24 by the cover 14 via the plurality of protruding portions 24d. This makes it possible to more effectively restrain vibration transmission to the engine side that supports the cover 14 and the housing 11.

Moreover, by employing three or more elastic plate-shaped protruding portions 24d, it is possible to elastically support annular attachment member 24 and stabilize its support posture, thereby making it possible to more effectively restrain vibration transmission to the support side such as the engine or a vehicle body.

In the present embodiment, when the protruding portions 24d of the annular attachment member 24 are just latched to the latching groove portion 14c of the cover 14, it is possible to elastically support the annular attachment member 24. This accordingly facilitates an attachment operation of the annular attachment member 24 to the cover 14. Besides, it is possible to easily mount a necessary number of pulsation dampers 20 on the inner peripheral wall portion 14a of the cover 14 without separately providing other attachment members, and to obtain a sufficient pulsation reduction effect.

Further, by means of the latching groove portion 14c of the cover 14, the plurality of protruding portions 24d projecting radially outwardly from the annular attachment member 24 are engaged with the inner peripheral wall portion 14a in the radial direction in a recess-projection manner. This makes it possible to easily and surely mount a necessary number of pulsation dampers 20 on the inner peripheral wall portion 14a of the cover 14 with a single touch.

Thus, the present embodiment provides the pulsation damper 20 and the high-pressure fuel pump 10 each of which is able to secure a sufficient pulsation damping performance by use of the plurality of different diaphragms 21, 22, and to restrain vibration transmission to the support side even if the diaphragms 21, 22 having different sizes are used together.

Note that, in the aforementioned embodiment, gas-chamber-23 sides of the first pressure-receiving film portion 21a of the first diaphragm 21 and the second pressure-receiving film portion 22a of the second diaphragm 22 are opposed to each other generally in parallel to each other. Shapes of the first pressure-receiving film portion 21a and the second pressure-receiving film portion 22a at the time when the fuel pressure in the fuel accumulation chamber 15 is a pressure (for example, an atmospheric pressure) of a cold operation do not need to be flat.

For example, as illustrated in FIG. 6, the shape of the first pressure-receiving film portion 21a of the first diaphragm 21 during the cold operation may be a curved arc sectional shape that projects (or may be recessed) toward an outer side of the gas chamber 23. Further, the shape of the first pressure-receiving film portion 21a of the first diaphragm 21 during the cold operation may have other uneven sectional shapes such as a waved section. Further, the shape of the second pressure-receiving film portion 22a of the second diaphragm 22 may be a curved arc sectional shape that projects (or may be recessed) toward the outer side of the gas chamber 23. The shape of the second pressure-receiving film portion 22a of the second diaphragm 22 may have other uneven sectional shapes such as a waved section.

Further, the annular attachment member 24 is formed from a sheet metal material. The annular attachment member 24 may have a tubular shape in which a large-diameter annular groove forming the large-diameter tubular support wall surface E1 and a small-diameter annular groove forming the small-diameter tubular support wall surface E2 are opened on both end sides in the axial direction. The annular attachment member 24 may be a tubular body or an annular body having, on its outer peripheral side, a stepped annular shape forming the large-diameter tubular support wall surface E1 and the small-diameter tubular support wall surface E2.

Further, in order to achieve easy and compact manufacture of the pulsation damper 20, it is preferable that the annular attachment member 24 be configured such that the large-diameter tubular support wall surface E1 and the small-diameter tubular support wall surface E2 are placed on the outer peripheral side of the annular attachment member 24. It is conceivable that the large-diameter tubular support wall surface E1 and the small-diameter tubular support wall surface E2 are placed on an inner peripheral side of the annular attachment member 24. In that case, the first diaphragm 21 and the second diaphragm 22 may each have a bottomed cylindrical shape projecting toward the gas-chamber-23 side, and may be configured such that outer peripheral sides of the first diaphragm 21 and the second diaphragm 22 are fitted into the annular attachment member so as to be fixed thereto by adhesive or the like. Further, the annular attachment member 24 may be a tubular body or an annular body including the large-diameter annular support portion 24a and the small-diameter annular support portion 24b on both axial end surfaces thereof.

The plurality of protruding portions 24d of the annular attachment member 24 each has an elastic plate shape formed in a claw shape. The plurality of protruding portions 24d of the annular attachment member 24 is not limited to any specific shape such as a plate shape or the like. The plurality of protruding portions 24d of the annular attachment member 24 may not be formed integrally with the annular attachment member 24. Further, the plurality of protruding portions 24d made from elastic members different from the annular attachment member 24 may be mounted on the outer peripheral side of the annular attachment member 24 or the annular coupling portion 24c.

Further, the high-pressure fuel pump 10 of the present invention uses the plunger 12 having a generally columnar shape as a pressurization member that reciprocates. The high-pressure fuel pump 10 of the present invention may use a piston having a large diameter on a fuel-pressurization-chamber-13 side.

As described above, the present invention provides a pulsation damper and a high-pressure fuel pump each of which is able to secure a sufficient pulsation damping performance by use of a plurality of diaphragms, and to restrain vibration transmission to a support side even if diaphragms having different sizes are used together. The present invention configured as such is useful for a general pulsation damper including a gas chamber formed by a diaphragm displaced at the time of receiving a pressure, and for a general high-pressure fuel pump including the pulsation damper.

1. A pulsation damper comprising:
a first diaphragm including a first pressure-receiving film portion displaced upon receipt of a pressure;
a second diaphragm including a second pressure-receiving film portion displaced upon receipt of a pressure, the second pressure-receiving film portion having a pressure receiving area different from a pressure receiving area of the first pressure-receiving film portion; and
an annular attachment member configured to support the first diaphragm and the second diaphragm from outer peripheral sides of the first and the second pressure-receiving film portions,
the annular attachment member including
a large-diameter annular support portion surrounding the first pressure-receiving film portion and supporting the first diaphragm,
a small-diameter annular support portion surrounding the second pressure-receiving film portion and supporting the second diaphragm, and
an annular coupling portion coupling the large-diameter annular support portion with the small-diameter annular support portion so as to close a gas chamber between the first pressure-receiving film portion and the second pressure-receiving film portion.

2. The pulsation damper according to claim 1, wherein
the large-diameter annular support portion and the small-diameter annular support portion have tubular support wall surfaces, and
the large-diameter annular support portion and the small-diameter annular support portion have different diameters.

3. The pulsation damper according to claim 2, wherein
the large-diameter annular support portion and the small-diameter annular support portion have the tubular support wall surfaces on respective outer peripheral sides of the large-diameter annular support portion and the small-diameter annular support portion, and
the annular coupling portion is placed between the large-diameter annular support portion and the small-diameter annular support portion and has an annular plate shape.

4. The pulsation damper according to claim 1, wherein
respective one sides of the first pressure-receiving film portion and the second pressure-receiving film portion are opposed to each other, the respective one sides defining the gas chamber, and
at least the second diaphragm out of the first diaphragm and the second diaphragm has a tubular member surrounding the second pressure-receiving film portion from the outer peripheral side of the second pressure-receiving film portion.

5. The pulsation damper according to claim 1, wherein
the annular attachment member includes protruding portions projecting radially outwardly.

6. The pulsation damper according to claim 5, wherein
the protruding portions are configured to be elastically deformed in a direction perpendicular to the first pressure-receiving film portion and the second pressure-receiving film portion.

7. The pulsation damper according to claim 5, wherein
the protruding portions are constituted by three or more elastic plate portions projecting radially outwardly from the annular attachment member.

8. The pulsation damper according to claim 5, further comprising
a support-side member, wherein the support-side member includes
an inner peripheral wall portion surrounding the annular attachment member from an outer peripheral side of the annular attachment member, and
a latching portion provided along the inner peripheral wall portion so as to latch the protruding portions of the annular attachment member to the inner peripheral wall portion.

9. The pulsation damper according to claim 8, wherein
a plurality of annular attachment members is provided inside the inner peripheral wall portion of the support-side member, and
the plurality of annular attachment members are supported so as to be axially separated from each other.

10. The pulsation damper according to claim 8, wherein
the protruding portions projecting radially outwardly from the annular attachment member are engaged with the inner peripheral wall portion by the latching portion in a radial direction in a recess-projection manner.

11. A high-pressure fuel pump comprising:
the pulsation damper according to claim 1;
an intake-side fuel accumulation chamber housing therein the pulsation damper;
an intake passage communicating with the intake-side fuel accumulation chamber; and
a fuel pressurization mechanism configured to pressurize a fuel introduced via the intake passage so as to discharge the fuel.
